(19) United States
(12) Patent Application Publication
(10) Pub. No.: US 2003/0054672 A1
(43) Pub. Date: Mar. 20, 2003

(54) Mounting device for sliding contacts

(76) Inventor: Kurt Dollhofer, Fuerstenfeldbruck (DE)

Correspondence Address: ST. ONGE STEWARD JOHNSTON & REENS, LLC, 986 BEDFORD STREET, STAMFORD, CT, 06905-5619, US

(21) Appl. No.: 10/216,368

(22) Filed: Aug. 8, 2002

(30) Foreign Application Priority Data
Aug. 9, 2001 (DE) 101 40 014.4

(51) Int. Cl. H01R 39/00

(52) U.S. Cl. 439/13

(57) ABSTRACT

The invention relates to a holding device for sliding contacts. The holding devices so far known require a very high expenditure for mounting or alignment. A flexible printed circuit board with mechanically rigid carrier elements that permit the adaptation to the geometry of the slipring enables a simple and low-cost structure.

This application claims priority of pending German Application No. 101 40 014 filed on Aug. 9, 2001.

### FIELD OF THE INVENTION

The present invention relates to a locating device for sliding contacts of the type used particularly with slip rings for the transmission of electrical signals between parts rotating relative to each other.

### BACKGROUND OF THE INVENTION

With conventional slip rings for the transmission of signals or for transmitting minor and medium currents, metal wires are preferably employed which run on round sliprings. In such a design, the metal spring is guided by an appropriate holder means relative to the slipring in such a manner that it is constantly maintained in a mechanically biased condition. This bias is required in order to ensure that a proper contact will be continuously maintained even in the case of positional tolerances and movements of the spring relative to the slipring. An example of such a locating device is disclosed in the U.S. Pat. No. 3,574,266. Such arrangements with a single contact spring only produce a comparatively high contact noise in operation, i.e. when the slipring is rotating. This contact noise is created by minute movements of the metal spring on the surface of the slipring.

Systems having more than just one metal spring display substantially better contact characteristics. In these cases, a parallel circuit including several possible current paths can be achieved. For example, when the contact between the first contact spring and the slipring is discontinued for a short period the current may continue flowing via a further contact spring. The probability of the second or of further contact wires losing the contact with the slipring at the same time is extremely low. Such a system with two contact wires is described in the U.S. Pat. No. 3,614,726. This system comprises pairs of contact wires fastened by means of soldered joints on a common locating and contacting wire. Even though such a system has good contacting characteristics it can be produced only with great difficulties because the contacting wires, the contact wires and the electrical terminal must be joined by soldering them individually. In the case of a slip ring assembly with a few contacts only, this work is less relevant than in the case of slip ring assemblies with high numbers of contacts. Apart therefrom, the spacing between the individual sliding contact wires is comparatively wide in such an arrangement so that in the case of many contacts consequently very large dimensions of the entire arrangement are achieved.

This problem is solved by an arrangement disclosed in the European Patent specification EP 0 662 736 B1. There, the contact spring is accommodated in a carrier consisting of an electrically conducting material or as printed circuit board coated with an electrically conductive material. In the case of sliprings having a comparatively small diameter, the contact spring may here be inserted into the carrier in a vertical position. With wider slipring diameters, the contact spring is bent closely towards the carrier at an appropriate angle.

This bending operation, however, must mostly be performed by hand, which requires, in its turn, a high expenditure in terms of labour. Moreover, when usual contact wires are used, which consist only of a single wire, the restitution constant is varied as a result of the deformations of the material at the site of the bend (cold hardening). Even though the manual alignment furnishes uniformly oriented contact wires these wires have different restitution constants and hence different forces pressing against the sliprings.

### SUMMARY OF THE INVENTION

The invention is based on the problem of providing a mounting means for contact wires (brushes), which does no longer present the aforedescribed disadvantages and which is easy to mount and to align, in particular, whilst it enables constant contact pressures of the contact wires.

One inventive solution to this problem is defined in Patent claim 1. Improvements of the invention are the subject matters of the dependent claims.

The inventive device consists of at least one flexible printed circuit board for contacting the contact wires, which is rigidified by stiffening elements for mechanically fixing the contact wires in such a way that it is able to take up the spring forces. In the present context, the term “flexible printed circuit board” in the sense of the invention is to be understood to denote the usual embodiment of flexible printed circuit boards with a dielectric substrate and conductor structures laminated thereon. This term equally encompasses also conductor structures consisting of a conductive material, which display properties of mechanical flexibility, such as conductor structures punched out of a thin metal sheet.

In accordance with the present invention, at least one flexible printed circuit board may be used for indirectly or directly contacting the contact wires as well as for mechanically holding them indirectly or directly. It is possible, for example, to fasten the contact wires by soldering them directly to soldering tags of the flexible printed circuit board. This leads to the establishment of a direct electrical contact. Indirect electrical contacting is possible because the carrier element or elements are contacted by the flexible printed circuit board and the contact wires are fixed in the carrier elements in such a way that they contact them electrically at the same time. The carrier elements as such may also be designed in the form of a mechanically rigid printed circuit board. Now the contact wires can be mechanically fixed in this printed circuit board by soldering, which creates a mechanical fixing and provides for electrical contacting at the same time.

Owing to the configuration of the locating and contacting means for the contact wires with a flexible printed circuit board, it is now possible to carry isolated groups of contact wires individually into the optimum position relative to the slipring. Hence, an optimum sliding position can be achieved in combination with the optimum contact pressure. The alignment is here carried out by precise positioning of the locating means rather than by bending of the individual contact wires. Hence, the initial restitution constant of the contact spring material is not influenced by cold hardening. Consequently, all contact wires now present similar resilience characteristics as far as possible. Moreover, there is no risk of overbending of the individual wires at a bending position. Owing to the optimum adaptation to the slipring extension, it is now possible as well to use shorter wires of the contact wires. As a result, a reduced mass is achieved with a higher limit frequency of the system, which results in a higher stability at strong vibrations, e.g. in vehicles.

In another expedient embodiment of the invention, at least one flexible printed circuit board is configured in the form of a rigid and flexible printed circuit board. With such printed circuit boards, rigid and flexible parts are joined by lamination. Consequently, a mechanically reliable connection of these elements is achieved in a single step. The electrical contacts are established by means of conductor paths located on both the rigid zones and the flexible zones.

In a further advantageous embodiment of the invention, at least one flexible printed circuit board or at least one carrier element is provided for receiving a plug or another connector means. Hence, a unit ready for connection can be produced for the accommodation of the contact wires. With the selection of a suitable mounting location it is possible to take special conditions into consideration such as a certain minimum rigidity of the mounting area of the plug or a maximum thickness of the printed circuit board.

Another preferred embodiment of the invention is characterised by the feature that additional active or passive components are mounted either on at least one flexible printed circuit board or on at least one carrier element. With slip rings, additional components such as filters, amplifiers, resistors or even fuses are often required. These elements are here particularly simple to integrate into one assembly. Specifically with major components it becomes possible to fasten them on the mechanically rigid carrier element because in the event that they are mounted on the flexible printed circuit board they could leap off after the printed circuit board has been bent.

In accordance with a further expedient embodiment of the invention, the mechanically rigid carrier elements are fastened by means of stable support members. These support members fix the carrier elements and the contact wires connected thereto in predetermined positions. The support members as such may be fastened in the housing of the slip ring, for instance.

Another embodiment of the invention provides for a movable or adjustable arrangement of the support members. With such a movable arrangement, it is possible to adjust the bearing angle or the contact pressure of the contact wires on the slipring. In distinction from prior art, such an arrangement permits even the alignment in the built-in condition and even with rotating sliprings. Apart therefrom, only an individual adjustment of the contact wires is possible in arrangements corresponding to prior art. On account of the fact that the contact wires are uniformly fixed by the carrier elements without alignment. Hence, an individual alignment is no longer required at all. Due to the complete alignment of all contact wires in a single operation by adjustment of the carrier elements or of the support members connected therewith, respectively, substantial savings can be achieved in labour—at an enhanced precision in alignment whilst misalignment of individual contact wires can be precluded. A locking means must be provided, of course, on the support members as well so that the latter may be permanently fixed for operation after alignment.

In accordance with the present invention, a method is proposed for electrically contacting sliding contacts running on sliprings for the rotary transmission of electrical signals. In that method, the sliding contacts are contacted by the employment of at least one flexible printed circuit board.

### BRIEF DESCRIPTION OF THE DRAWINGS

The invention will be described in the following by exemplary embodiments, without any restriction of the general inventive idea, with reference to the drawings wherein:

FIG. 1 illustrates a general embodiment of the invention, which comprises support members;

FIG. 2 an embodiment of the invention, which comprises conducting paths for contacting;

FIG. 3 is a view of a multiple arrangement of contact wires, and

FIG. 4 shows an embodiment with an additional electronic component.

### DETAILED DESCRIPTION OF THE DRAWINGS

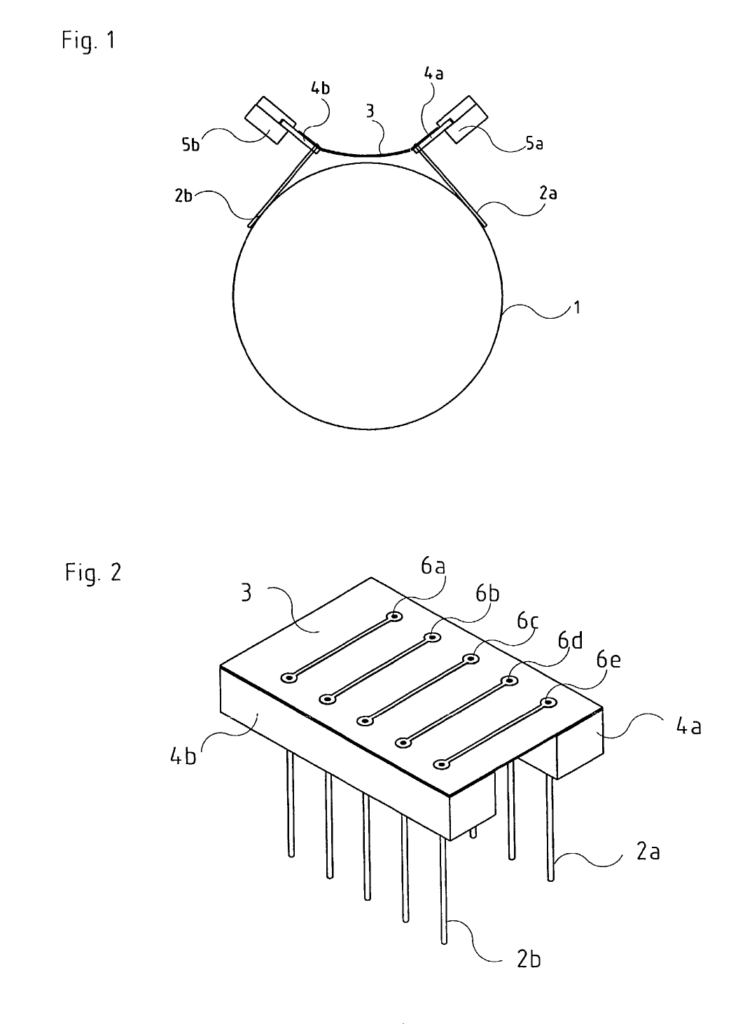

FIG. 1 illustrates an inventive device in a general form. There, a first set of contact wires (2a) as well as a second set of contact wires (2b) runs along a slipring (1). The contact wires are mechanically fixed by means of a first mechanically rigid carrier element (4a) as well as by means of a second mechanically rigid carrier element (4b), which elements are connected to each other by means of a flexible printed circuit board (3).

FIG. 2 is a perspective view of an inventive device comprising additional conducting paths for contacting and connecting the contact wires. Here, each of the contact wires of the first set of contact wires (2a) is connected to the corresponding contact wires of the second set of contact wires (2b) by means of the conducting paths (6a, 6b, 6c, 6d, 6e) disposed on the flexible printed circuit board (3).

FIG. 3 discloses an exemplary array including four sets of contact wires running on a set of sliprings. Here, four contact wires run on each slipring. These wires are electrically connected to each other by means of a flexible printed circuit board.

In FIG. 4, the additional integration of an electronic component on the flexible printed circuit board (3) is illustrated in an exemplary form. Such an electronic component may be a transformer, an amplifier or even a connector, for instance.

1. A device for holding and contacting a first set of contact wires (2a) for sliprings, said contact wires contacting said sliprings at specified angles between said contact wires and tangents to said sliprings, and said device having a mechanically rigid carrier element (4a) for mechanically fixing said contact wires, characterized in that
at least one second mechanically rigid carrier element (4b) is provided for mechanically holding at least a second set of contact wires (2b) and that said carrier elements are connected to each other by at least one flexible printed circuit board (3).

2. A device according to claim 1, characterized in that
at least one of said flexible printed circuit boards for contacting said contact wires directly contacts at least some or all of said contact wires electrically.

3. A device according to claim 1, characterized in that
at least one of said carrier elements is configured as a rigid printed circuit board.

4. A device according to claim 1, characterized in that
at least one of said flexible printed circuit boards is designed in the form of a rigid and flexible printed circuit board, having rigid zones and flexible zones which are laminated one on top of the other.

5. A device according to claim 1, characterized in that
at least one of said flexible printed circuit boards is additionally designed for accommodating a connector means such as a plug or a socket.

6. A device according to claim 1, characterized in that
at least one of said flexible printed circuit boards comprises additionally active or passive components such as filters or amplifiers.

7. A device according to claim 1, characterized in that
said mechanically rigid carrier elements are supported on stable support members (5a, 5b).

8. A device according to claim 7, characterized in that
said stable support members are adjustably mounted so that the angles between the contact wires and the tangents to the slipring at the respective points of contact or the contact pressure of said contact wires against said sliprings can be adjusted.

9. Method of electrically contacting sliding wire contacts, by using at least one flexible printed circuit board to contact the wire contacts.
